(19) United States
(12) Patent Application Publication
(10) Pub. No.: US 2001/0035124 A1
(43) Pub. Date: Nov. 1, 2001

(54) Substrate processing apparatus and semiconductor manufacturing method

(76) Inventors: Satohiro Okayama, Tokyo (JP); Kazunori Suzuki, Tokyo (JP); Satoru Ichimura, Tokyo (JP); Teruo Yoshino, Tokyo (JP); Tokunobu Akao, Tokyo (JP); Yasunobu Nakayama, Tokyo (JP); Kazunori Tsutsuguchi, Tokyo (JP)

Correspondence Address: OLIFF & BERRIDGE, PLC, 277 S. WASHINGTON STREET, SUITE 500, ALEXANDRIA, VA, 22314, US

(21) Appl. No.: 09/796,483

(22) Filed: Mar. 2, 2001

(30) Foreign Application Priority Data
Mar. 2, 2000 (JP) 2000-57601
Feb. 28, 2001 (JP) 2001-55012

(51) Int. Cl. B05C 11/02

(52) U.S. Cl. 118/110

(57) ABSTRACT

Throughput is increased, the footprint is reduced, heating may be carried out in a short time, and variations in the temperature of the substrate surface may be reduced. A heating chamber 47 for heating the substrate is formed as an upper level of a load/lock chamber 13, and a cooling chamber 48 for cooling the substrate is formed as a lower level of the load/lock chamber 13. An upper heater 51 and a lower heater 56 are formed above and below the heating chamber 47. A shower plate 52 is located between the upper heater 51 and the lower heater 56. A gas heating space 50 is located between the upper heater 51 and the shower plate 52. An N₂ gas introducer 42 is connected to the gas heating space 50, such that N₂ gas is introduced into the gas heating space 50. The N₂ gas introduced from the N₂ gas introducer 42 is heated in the gas heating space 50 and is then supplied to the substrate W in the form of a shower via the shower plate 52. The substrate W is subjected to convection heat transfer from the N₂ gas that underwent radial heat transfer from the upper heater 51, as well as from the heated N₂ gas, and is also heated by the lower heater 56.

### BACKGROUND OF THE INVENTION

1. Field of the Invention

The present invention relates to a substrate processing apparatus such as a CVD apparatus, a dry etching apparatus, an ashing apparatus or a sputtering apparatus used in the manufacture of LCDs or semiconductor devices, as well as to a semiconductor manufacturing method.

2. Description of the Related Art

First, the construction of a conventional cluster-type LCD substrate processing apparatus and the movement of the substrate are explained with reference to FIG. 9. The LCD substrate processing apparatus has in the center thereof a heptagonal or octagonal vacuum conveyance chamber 25. Around the periphery of this vacuum conveyance chamber 25 are located a preparatory heating chamber 23 that carries out preparatory heating of substrates, a load/lock chamber 22 that alternates the ambient environment for the substrates between an air atmosphere and a vacuum, and a film formation chamber 24 in which films are formed on the substrates. Furthermore, the substrates are conveyed inside the apparatus from a substrate cassette 21, which is under atmospheric pressure, by means of an air conveyance robot not shown in the drawing. The substrate conveyance paths are indicated by the arrows in the drawing. They will now be explained.

The substrate is conveyed from the substrate cassette 21 located in an air atmosphere to the load/look chamber 22, The interior of the load/lock chamber 22 is changed from the atmospheric pressure conditions to high-vacuum conditions. The substrate is then conveyed to the preparatory heating chamber 23 via the vacuum conveyance chamber 25 using the vacuum conveyance robot 26. A heater (not shown in the drawing) used to perform non-contact heating of the substrate is located inside the preparatory heating chamber 23. When this occurs, a high vacuum exists inside both the preparatory heating chamber 23 and the vacuum conveyance chamber 25.

The substrate conveyed to the preparatory heating chamber 23 is heated to the film formation temperature via radial heat transfer from the heater located inside the preparatory heating chamber 23. The substrate heated to the film formation temperature is conveyed to the film formation chamber 24 via the vacuum conveyance chamber 25. The substrate undergoes film formation processing in the film formation chamber 24, is conveyed to the load/look chamber 22 via the vacuum conveyance chamber 25, and the ambient conditions are changed from a high vacuum to an atmospheric pressure. Once the atmospheric pressure conditions are established in the load/lock chamber 22, the substrate is returned to the substrate cassette 21 by the air conveyance robot not shown in the drawing after the load/look chamber 22 is opened to be cooled naturally.

The load/lock chamber 22 comprises a vacuum container 30 and has a chamber 41 therein, as shown in FIG. 10. An exhaust outlet 32 used to evacuate the air inside the chamber and create high vacuum conditions therein is located at the bottom area the vacuum container 30. An exhaust valve 33 is attached to the exhaust outlet 32. Located at the left and right sides of the load/lock chamber 22 respectively are an atmosphere side gate valve 31 and a high vacuum side gate valve 35. The substrate W delivered into the load/lock chamber 22 is supported by a plurality of substrate support pins 34, and is cooled naturally during turning the load/lock chamber 22 from the reduced-pressure conditions to the normal atmospheric pressure conditions by supplying the inert gas, and the atmosphere side gate valve 31 is opened.

However, the conventional load/lock apparatus described above has the following problems. Because a load/lock chamber and a preparatory heating chamber are required in addition to the film formation chamber used for film formation processing of the substrate, the throughput of the apparatus decreases, and the apparatus has a large footprint, increasing the cost of manufacture. Moreover, when the substrate undergoes preparatory heating by a heater, because heating is carried out only through radial heat transfer in a vacuum, a long time is required for heating, reducing the throughput of the apparatus. Furthermore, because the heating is performed by only a heater, the substrate is not heated uniformly and there are large temperature variations on the substrate surface. In addition, a long cooling time is required for natural cooling of the substrate, which also contributes to lower throughput.

The present invention eliminates these problems arising in the conventional art, and provides a substrate processing apparatus and semiconductor manufacturing method by which throughput may be increased.

### SUMMARY OF THE INVENTION

A first aspect of the invention is a substrate processing apparatus comprising a substrate processing chamber that processes substrates, a front chamber that houses unprocessed or processed substrates, and a conveyance apparatus that conveys said substrates to the processing chamber or to the front chamber, in which said front chamber is provided with an inert gas supply unit that supplies to the front chamber inert heating gas for heating the substrates or inert cooling gas for cooling the substrates.

Where the inert gas supply unit provides only inert heating gas, the front chamber becomes a heating chamber. The ability to efficiently subject the substrate to preparatory heating in the front chamber eliminates the time required to carry out preparatory heating in the processing chamber, or at least reduces it considerably. For the cooling process, a cooling chamber may be separately from the front chamber, or, alternatively, natural cooling may be carried out in the front chamber. Where the inert gas supply unit supplies only inert cooling gas, the front chamber becomes a cooling chamber. The ability to efficiently cool the substrate in the front chamber allows the cooling time to be reduced considerably. A heating chamber is provided separately from the cooling chamber. Where the inert gas supply unit supplies both inert heating gas and inert cooling gas, the front chamber serves as both a heating chamber and a cooling chamber. In this case, the inert heating gas and the inert cooling gas may be supplied using different systems or using the same system, such that either gas may be selectively supplied.

The front chamber is a chamber that is used as a load/lock chamber, as a heating/cooling chamber, or as both a load/look chamber and a heating/cooling chamber. The conveyance apparatus may be located inside a conveyance chamber that is independent from the substrate processing chamber and the front chamber, or it may be located inside the front chamber without the existence of an independent conveyance chamber. For example, the conveyance apparatus may be located inside the load/lock chamber, which would then serve as both a load/lock chamber and a conveyance chamber.

Because the first aspect of the invention has an inert gas supply unit in the front chamber, and unprocessed substrates undergo direct preparatory heating, or alternatively, processed substrates are directly cooled, via convection heat transfer, the heating or cooling of the substrates may be speeded up. As a result, the time required for heating and cooling may be reduced, and throughput may be increased. The inert gas may in general be either N₂ gas or argon gas. The substrate may be a glass substrate, a semiconductor wafer, etc.

In the apparatus of the above invention, it is preferred that the inert gas supply unit supply gas to the substrate in the form of a shower. When the inert gas is supplied to the substrate in the form of a shower, the heating or cooling effect is transmitted to the entire surface of the substrate, allowing uniform heating or cooling of the substrate. This reduces the time needed for heating of the substrate, as well as the degree of temperature variation on the substrate surface, and improves temperature uniformity on the substrate surface.

In the apparatus of the above invention, it is preferred that the apparatus comprise a partition that divides the front chamber into a heating chamber and a cooling chamber, a communicating part through which the heating chamber communicates with the cooling chamber, and an exhaust outlet from which gas is exhausted from the front chamber through the communicating part. When the front chamber is divided into a heating chamber and a cooling chamber, the movement of heat energy between the heating chamber and the cooling chamber is reduced, thereby permitting more efficient heating and cooling of the substrate. Moreover, when a communicating part is formed that communicates the heating chamber and the cooling chamber, the inert gas supplied to the interior of the front chamber may be evacuated using a simple construction involving only one exhaust outlet.

In the apparatus of the above invention, it is preferred that the front chamber comprise a load/look chamber. When the front chamber comprises a load/lock chamber and inert heating gas or inert cooling gas is supplied to and evacuated from this load/lock chamber, a substrate heating chamber or a substrate cooling chamber may be eliminated. This reduces the size of the apparatus footprint and lowers the cost of manufacture. Furthermore, because the carrying out of heating or cooling in the load/look chamber allows substrates to enter and leave the chamber while a vacuum state is maintained inside the chamber, the throughput may be increased.

In the apparatus of the above invention, it is preferred that one load/lock chamber, one conveyance apparatus and one processing chamber be linearly aligned. The substrate processing apparatus may also comprise a cluster system having a plurality of processing chambers. However, where the substrate processing apparatus comprises a so-called monoline system in which each component is connected to the others in a one-to-one fashion, as in the apparatus of the present invention, the footprint may be reduced in size. Furthermore, the apparatus of the present invention offers the advantages that the cost of each substrate processing apparatus may be reduced, customers can order only the number of apparatuses they require, and customers can freely select the number of processing chambers they require. Furthermore, because each processing chamber incorporates a conveyance apparatus in a monoline system, the rate of operation of each processing chamber may be increased. Because a monoline system offers greater system design flexibility and a higher operating efficiency, the productive efficiency of each chamber when producing semiconductor devices or LCDs may be increased.

In the apparatus of the above invention, it is preferred that the conveyance apparatus have two conveying arms capable of conveying the substrates. If the conveyance apparatus has two conveying arms, the conveyance of substrates may be carried out between the substrate processing chamber and the front chamber by two arms in a parallel fashion, and therefore the monoline system may be operated in an even more efficient manner.

A second aspect of the invention comprises a semiconductor manufacturing method comprising the steps of: in the load/lock chamber that houses unprocessed or processed substrates, subjecting the unprocessed substrates to preparatory heating using inert heating gas, or cooling the processed substrates using inert cooling gas; and conveying the pre-heated substrates from the load/lock chamber to the substrate processing chamber, or conveying the processed substrates from the substrate processing chamber to the load/look chamber, by means of the conveyance apparatus for conveying substrates, in which the substrates are linearly conveyed between the load/look chamber and the substrate processing chamber.

Using the second aspect of the invention, because the substrate may be efficiently heated or cooled through convection heat transfer in the load/look chamber into which substrates may be conveyed while a vacuum state is maintained therein, the throughput is increased. Moreover, because substrates are linearly conveyed between the load/lock chamber and the substrate processing chamber, the operating efficiency of the apparatus is higher compared to an apparatus in which the substrates are not linearly conveyed. This semiconductor manufacturing method is not only a method for manufacturing semiconductor devices, but may also be used to manufacture LCDs (liquid crystal devices).

In the method of the above invention, it is preferred that unprocessed substrates be delivered into the load/lock chamber and that they completely undergo preparatory heating while substrates are being processed in the substrate processing chamber. If unprocessed substrates are delivered into the load/lock chamber and completely undergo preparatory heating while substrates are being processed in the substrate processing chamber, each substrate may be processed in the substrate processing chamber immediately after the previous substrate was processed, and therefore the throughput may be increased.

In the method of the above invention, it is preferred that the conveyance apparatus have two conveying arms, and, at the same time that an unprocessed substrate that has completely undergone preparatory heating is received by one arm, a processed substrate is received from the substrate processing chamber by the other arm, next, at the same time that the substrate that has completely undergone preparatory heating is delivered into the substrate processing chamber by the above-mentioned one arm, the processed substrate is delivered into the cooling chamber by said the other arm.

Moreover, immediately after a processed substrate is received from the substrate processing chamber and is removed from the processing chamber by the other arm, the processing chamber becomes empty and enters a state in which the next unprocessed substrate may be delivered.

Because the conveyance apparatus has two conveying arms, the conveyance of substrates may be carried out between the substrate processing chamber and the front chamber in parallel using the two arms, thereby permitting efficient operation of the apparatus. Moreover, because the timings of the receiving the unprocessed substrate and the receiving the processed substrate by the two arms are synchronized, and the timings of the delivering the unprocessed substrate into the substrate processing chamber and the delivering the processed substrate into the cooling chamber by the two arms are synchronized to ensure continuous operation, throughput may be further increased.

### BRIEF DESCRIPTION OF THE DRAWINGS

FIG. 1 is a vertical cross-section of a load/lock chamber that comprises a component of a substrate processing apparatus comprising an embodiment of the present invention;

FIG. 2 is an enlarged view of the top part of the load/lock chamber;

FIG. 3 is an overall construction drawing of the substrate processing apparatus of the embodiment;

FIG. 4 is a plan view to explain the construction of the substrate processing apparatus of the embodiment as a monoline system,

FIG. 5 is a schematic vertical cross-section of the L/L chamber that comprises a component of a variation of the embodiment;

FIG. 6 is a sectional plan view of the partition plate shown in PIG. 5;

FIG. 7 is a schematic vertical cross-section of the L/L chamber that comprises a component of another variation of the embodiment;

FIG. 8 is a sectional plan view of the partition plate shown in FIG. 7;

FIG. 9 is a drawing of the construction of a conventional cluster-type substrate processing apparatus: and

FIG. 10 is a vertical cross-section of a conventional load/lock chamber.

### DESCRIPTION OF THE PREFERRED EMBODIMENTS

Embodiments of the present invention will be described below.

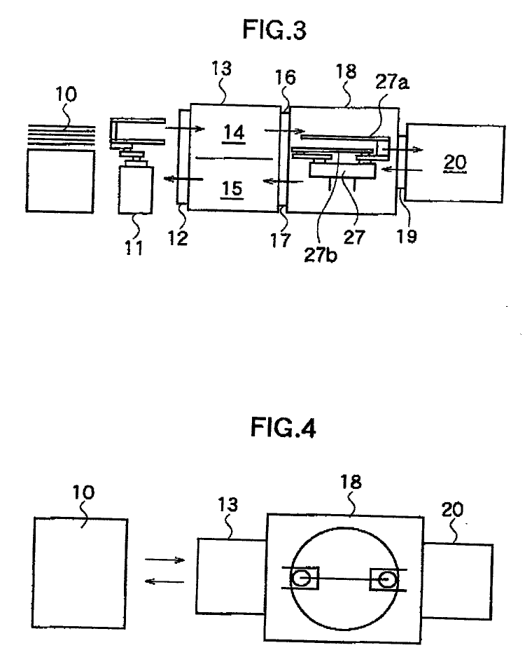

First, the construction of an LCD substrate processing apparatus that performs processing of glass substrates and the movement of the substrate will be explained with reference to FIGS. 3 and 4. The substrate processing apparatus comprises a so-called monoline system in which one load/lock chamber (hereinafter referred to as an L/L chamber) constituting a front chamber, one vacuum conveyance chamber (hereinafter T-chamber) 18 and one substrate processing chamber (hereinafter R-chamber) 20 are aligned in a straight line. Because each processing chamber has a vacuum conveyance chamber in a monoline system construction, unlike a cluster system in which a plurality of processing chambers are connected to one conveyance chamber, the operating efficiency of the processing chamber may be improved. In addition, because substrates are linearly conveyed between the L/L chamber 13 and the substrate processing chamber 20, throughput is increased relative to the situation in which substrates are not linearly conveyed.

The substrate processing apparatus has a T-chamber 18 in-the center, as well as an L/L chamber 13 that serves as a front chamber for this T-chamber, and that carries out preparatory heating of each substrate while changing the ambient atmosphere surrounding the substrate in the L/L chamber from atmosphere to a vacuum and vice versa. The substrate processing apparatus also has an R-chamber 20 that serves as a rear chamber for the T-chamber 18, and that carries out film formation on the substrate. The interior of the L/L chamber 13 is constructed with an upper and a lower level, wherein the upper level is a heating chamber (hereinafter H-chamber) 14 that carries out preparatory heating of each substrate, and the lower level is a cooling chamber (hereinafter C-chamber) 15 that carries out cooling. In particular, because the LCD substrate processing apparatus handles glass substrates, an extremely long amount of time is required until the processing temperature is reached. As a result, it is essential that the substrate undergo preparatory heating in order to increase throughput.

A vacuum conveyance robot 27 is located in the T-chamber 18 as a substrate conveyance apparatus. The vacuum conveyance robot 27 has two arms (double arms) 27a and 27b that can convey substrates. When the vacuum conveyance robot 27 has two conveying arms 27a and 27b, the conveyance of substrates between the R-chamber 20 and the L/L chamber 13 can be carried out in a parallel fashion using the two arms.

10 is a substrate cassette that sits on a cassette stand located in the atmosphere outside the L/L chamber 13, 11 is an atmosphere conveyance robot located between the substrate cassette 10 and the L/L chamber 13, 12 is an atmosphere side gate valve located on one side of the L/L chamber 13, 16 is an H-chamber side gate valve located between the H-chamber 14 and the. T-chamber 18, 17 is a C-chamber side gate valve located between the C-chamber 15 and the T-chamber 18, and 19 is an R-chamber side gate valve located between the T-chamber 18 and the R-chamber 20. The substrate conveyance paths are indicated by the arrows in the drawing.

In other words, a substrate is delivered from the open-air substrate cassette into the H-chamber 14 of the L/L chamber 13 via the atmosphere conveyance robot 11, and the air in the L/L chamber 13 is evacuated until a high vacuum state is reached. After the air is evacuated, the substrate is heated to the film formation temperature by inert heating gas supplied by the inert gas supply unit located in the L/L chamber 13. After a high vacuum state is reached inside the L/L chamber 13, the heated substrate is conveyed to the R-chamber 20 via the vacuum conveyance robot 27 located in the T-chamber 18. After the substrate undergoes film formation in the R-chamber 20, it is conveyed to the C-chamber 15 comprising the lower level of the L/L chamber 13, and then, by supplying inert cooling gas by the inert gas supply unit, the L/L chamber 13 is turned until normal atmospheric pressure is reached while the substrate is cooled to a prescribed temperature. After turning to normal atmospheric pressure, the substrate is in a state of being cooled enough, and the atmosphere side gate valve 12 is opened and the substrate is carried out onto the substrate cassette 10 by the atmosphere conveyance robot 11 Cooling here may be carried out by natural cooling rather than by forced cooling using inert gas.

The two arms 27a and 27b of the vacuum conveyance robot 27 are constructed such that they can convey substrates independently of each other. For example, after one arm 27a carries a substrate W out from the L/L chamber 13, the other arm 27b can carry out another substrate from the film formation chamber 20. After one arm 27a brings the substrate W into the film formation chamber 20, the other arm 27b can bring a substrate W into the L/L chamber 13. When one arm 27a is waiting in the conveyance chamber 18, the other arm 27b may also be waiting in the conveyance room 18. After waiting, when conveyance is begun, the two arms may move past each other in opposite directions.

Where the vacuum conveyance robot 27 has two conveying arms, because substrates may be moved back and forth between (brought into and carried out of) the substrate processing chamber 20 and the L/L chamber 13 in a parallel fashion using the two arms, the monoline system may be operated efficiently.

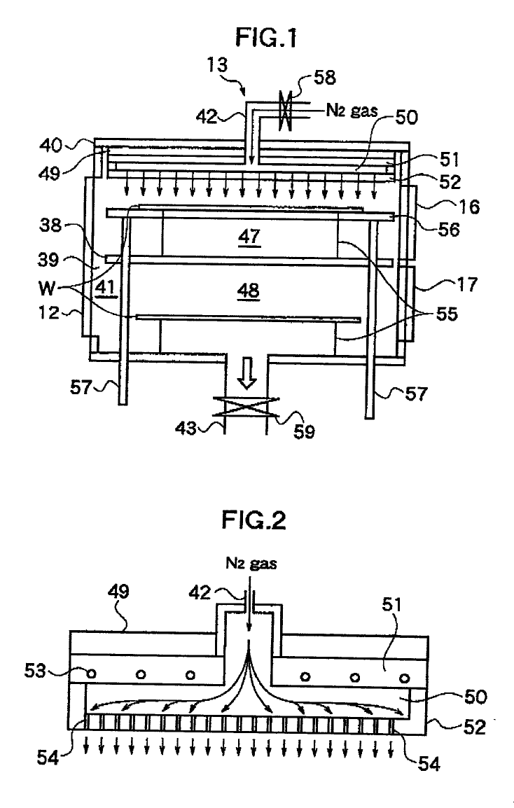

Next, the L/L chamber 13 of this embodiment will be explained in detail with reference to FIGS. 1 and 2. As shown in FIG. 1, the load/lock chamber 13 comprises a vacuum container 40 and has a chamber 41 therein. An N₂ gas introducer 42 that introduces N₂ gas as an inert heating gas into the chamber 41 is located at the top center area of the vacuum container 40. At the bottom of the container, a single exhaust outlet 43 used to evacuate the introduced N₂ gas is connected to the container via an exhaust valve 59. An atmosphere side gate valve 12, an H-chamber gate valve 16 and an L/L chamber gate valve 17 are located at the left, right and bottom areas of the container 40, respectively. The gate valves 16 and 17 may be combined into a single valve.

An H-chamber 47 and a C-chamber 48 are located inside the chamber 41. The H-chamber 47 and the C-chamber 48 can heat or cool a single glass substrate, respectively. The H-chamber 47 and C-chamber 48 are separated by a partition plate 38 formed from an insulating material, such that they form an upper and lower level. A communicating part 39 that communicates the H-chamber 47 and the C-chamber 48 is formed in the partition plate 38 located in the center of the chamber 41. The formation of this communicating part 39 enables the air in the interior of the chamber 41 of the L/L chamber 13 to be evacuated using the single exhaust outlet 43. For example, the communicating part 39 is located along the external chamber wall 40. The H-chamber side gate valve 16 is located at a position corresponding to the upper-level H-chamber 47, and the L/L chamber side gate valve 17 is located at a position corresponding to the lower-level C-chamber 48.

A gas heating space 50 in which N₂ gas is heated is located in the upper part of the H-chamber 47. The gas heating space 50 is the space formed between the upper heater 51 and the shower plate 52. The space is connected to the N₂ gas introducer 42 located at the top of the apparatus. An insulating material 49 is located above the upper heater 51 to cover it, and has the same function as a reflecting plate. In order to make the gas heating space 50 a heating space, the shower plate 52 should also be made of a heat-conductive material such as aluminum alloy, thereby thermally linking it to the upper heater 51. As shown in FIG. 2, the upper heater 51 is formed from a plate member in which heater wires 53 are embedded, and a number of holes 54 through which N₂ gas is sprayed onto the substrate W in the chamber 41 are formed in the shower plate 52.

The substrate W delivered into the H-chamber 47 is supported by a plurality of substrate support pins 55. A plate-shaped lower heater 56 that forms a pair with the upper heater 51 is formed on lower heater elevator rods 57 such that it can be raised and lowered. When necessary, the lower heater 56 can be raised such that it comes into contact with and supports the surface of the substrate W instead of the substrate support pins 55, and heats the substrate W. The lower heater 56 is separated from the substrate W by being lowered. Therefore, the substrate W in the H-chamber 47 is heated through the application of inert heating gas from the N₂ gas introducer 42 that is heated by the heater, and is also heated by the lower heater 56. Similarly, the substrate W delivered into the C-chamber 48 is supported by multiple substrate support pins 55. The substrate V inside the C-chamber 48 is either cooled through the application of inert cooling gas from the N₂ gas introducer 42 with the heater off, or is cooled inside the C-chamber 48 through natural cooling. The inert gas supply unit comprises the N₂ gas introducer 42, the gas heating space 50 and the shower plate 52.

The substrate processing and conveyance procedure of the monoline system having the double-arm conveyance robot 27 described above will now be explained, The conditions for each process are as shown in Table 1.

TABLE 1

| Process | Preparatory | Film formation | Substrate |
|---|---|---|---|
| name | heating | processing | cooling |
| Temperature | 200-350° C. | 200-350° C. | 100° C. or lower |
| | Preheat to film | Same as | No higher than |
| | formation | preparatory | heat resistance |
| | temperature | heating | temperature of |
| | | temperature | cassette, etc. |
| Pressure | 10-100Pa | SiN film: 133- | Stop |
| | (conveyance | 400Pa | evacuation. |
| | pressure 0.1- | a-Si film: 66.7- | return from |
| | 10Pa) | 200Pa | conveyance |
| | | N^{+a}-Si film: 66.7- | pressure to |
| | | 200Pa | normal |
| | | | atmospheric |
| | | | pressure |
| | | | (conveyance |
| | | | pressure 0.1- |
| | | | 10Pa) |
| Gas type | Inert gas such | SiN film: SiH₄ | Inert gas such |
| | as N₂, Ar | NH₃ | as N₂, Ar |
| | | (sometimes H₂) | |
| | | a-Si film: SiH₄ | |
| | | H₂ | |
| | | N^{+a}-Si film: SiH₄ | |
| | | H₂ | |
| | | PH₃ | |
| Gas flow | 1-20 1/min | 1-30 1/min | 200-400 1/min |
| rate | | | |

1) when the gate valve 12 on the side of the substrate cassette 10 of the L/L chamber 13 is opened, a substrate A (in the processes below, the substrates W will instead be identified as substrates A, B, C, . . . n−1, n) is conveyed to the L/L chamber 13 from the cassette 10 located outside the apparatus. After the substrate A is set on the substrate support pins 55 in the H-chamber 47, the gate valve 12 is closed (time required for this process; 10-13 seconds).

Where the substrate A is to be heated while in contact with, the lower heater 56, at the same time that the gate valve 12 is closed, the lower heater 56 is raised by the lower heater drive unit 57 to the position at which the substrate A rides on the top surface of the lower heater 56. When this occurs, the interior of the chamber 41 comprises atmosphere. Power is then supplied to he upper heater 51 and lower heater 56, thereby turning the heaters ON.

2) After it is confirmed that the gate valve 12 is closed, the exhaust valve 59 is opened and the air inside the L/L chamber 13 is evacuated until a prescribed pressure is reached. After the air is evacuated, the exhaust valve 59 is closed. When the N₂ gas valve 58 of the N₂ gas introducer 42 located at the top of the chamber 41 is opened after the pressure has been reduced to a prescribed pressure in accordance with the process conditions of Table 1, the N₂ gas passes through the N₂ gas introducer 42 and enters the gas heating space 50 (see FIG. 2). Because the gas heating space 50 is in contact with the lower surface of the upper heater 51, the N₂ gas is heated to a high temperature as it passes through this space. The heated N₂ gas in the gas heating space 50 is sprayed onto the entire surface of the substrate W via the shower plate 52 having a gas spraying function by virtue of its having a large number of holes formed therein. The substrate W in heated both by radial heat from the upper heater 51 and by convection heat from the upper heater 51 via the high-temperature N₂ gas that flowed past the upper heater 51. As a result, the time required to heat the substrate may be reduced, and fluctuations in the heating of the substrate surface may be prevented. In the situation in which the substrate W is in contact with the upper surface of the lower heater 56, heating is also carried out through heat transfer from the lower heater 56, and consequently the time required to heat the substrate W may be further reduced. In this way, the substrate A may be subjected to preparatory heating (preparatory heating time: 30-60 seconds) through the supply of inert heating gas.

3) After the substrate A undergoes preparatory heating to the film formation temperature shown in Table 1, the exhaust valve 59 is opened. The pressure inside the chamber 41 is reduced through the evacuation of the N₂ gas in the chamber 41 via the exhaust outlet 43, and the interior of the chamber 41 thereupon enters a high vacuum state. After the high vacuum state is confirmed, if the lower heater 56 is in the raised position, the lower heater 56 is lowered. The processing chamber side gate valves 16 and 17 of the L/L chamber 13 and the gate valve 19 of the processing chamber 20 are opened, and the substrate A is conveyed from the L/L chamber 13 to the processing chamber 20 by either of the arms of the conveyance robot 27. When conveyance is completed, the gate valves 16, 17 and 19 are closed (conveyance time: approx. 20 seconds).

The conveyance pressure during conveyance from the L/L chamber 13 to the processing chamber 20 is the same as the preparatory heating pressure, as shown in Table 1, but where the conveyance pressure is to be different from the preparatory hating pressure, a process in which the pressure is adjusted such that the conveyance pressured is reached is added after preparatory heating.

4) Prescribed substrate processing is carried out in the processing chamber 20. This prescribed substrate processing comprises, for example, continuous processing under one of the processing conditions described above, or under a combination of two or more of the processing conditions (substrate processing time: 100 seconds to three minutes).

5) When the gate valves 16 and 17 of the L/L chamber 13 are closed, the process of returning the L/L chamber 13 to normal atmospheric pressure is carried out. When the L/L chamber 13 is returned to normal atmospheric pressure, the cassette side gate valve 12 of the L/L chamber 13 is opened as described in process 1), the substrate B to be used in the next processing session is conveyed from the cassette 10 to the L/L chamber 13, and the gate, valve 12 is closed (prescribed time: 30-60 seconds).

6) The substrate B is subjected to preparatory heating through the supply of inert heating gas while the pressure in the interior of the L/L chamber 13 is reduced to a prescribed level under the conditions described in process 2) above (preparatory heating time: 30-60 seconds).

The preparatory heating may be completed by the time that the prescribed substrate processing is completed in the processing chamber 20.

7) When the prescribed processing in the processing chamber 20 is completed, the gate valve 19 of the processing chamber 20 and the processing chamber side gate valves 16 and 17 of the L/L chamber 13 are opened. At the same time that the unprocessed substrate B that has completely undergone preparatory heating is received by the arm 27a of the conveyance robot 27, the processed substrate A is received from the processing chamber 20 by the arm 27b. Next, at the same time that the substrate 8 that has completely undergone preparatory heating is delivered into the processing chamber 20 by the arm 27a, the processed substrate A is delivered into the cooling chamber 15(48) by the arm 27b. And the gate valve 19 of the processing chamber 20 is closed (total time for this process: 15-20 seconds).

8) Substrate processing is begun once more in the processing chamber 20 (substrate processing time: 100 seconds to three minutes).

The conveyance pressure during conveyance from the processing chamber 20 to the L/L chamber 13 is the same as the substrate cooling pressure, as shown in Table 1, but where the substrate cooling pressure is to be different from the conveyance pressure, a process in which the pressure is adjusted such that the substrate cooling pressure is reached is added after conveyance.

9) The exhaust valve 59 is closed, and the interior of the L/L chamber 13 is returned to normal atmospheric pressure while the substrate A is cooled with inert gas. Inert cooling gas or room-temperature N₂ cooling gas is supplied to the chamber 41 from outside the apparatus via the gas introducer 42, and the processed substrate A inside the C-chamber 48 is cooled to a low temperature (time required to return to normal atmospheric pressure and cool substrate: 20-30 seconds).

10) When the substrate A is cooled and the interior of the L/L chamber 13 is returned to normal air pressure, the cassette side gate valve 12 of the L/L chamber 13 is opened, the substrate A is conveyed from the L/L chamber 13 to the cassette, the substrate C to be used in the next processing session is conveyed from the cassette 10 to the L/L chamber 13, and the cassette side gate valve 12 of the L/L chamber 13 is closed (time required: 15-30 seconds).

It is acceptable if the cooling of the substrate is not forced cooling, but rather natural cooling involving no gas supply. In this case, because the C-chamber 48 is separated from the H-chamber 47 by the partition plate 38, the cooling process is not affected by the H-chamber 47.

11) The processes described in processes 6) through 11) above are then repeatedly performed until the last substrate n is processed. However, while the substrate n−1 is extracted to the cassette 10 in the processes 9) through 11) above, because the substrate n is the last substrate, no substrate for the subsequent processing session is conveyed from the cassette 10 to the L/L chamber 13 in the process 8) for the last substrate n.

12) When processing of the final substrate n is completed, the processed substrate n is removed from the processing chamber 20 and conveyed to the L/L chamber 13 (conveyance time: approx. 20 seconds).

13) The interior of the L/L chamber 13 is returned to normal atmospheric pressure while the substrate n is cooled (time required for return to normal atmospheric pressure and cooling; 20-30 seconds).

14) The substrate n in the L/L chamber 13 is placed on the cassette 10 (time required: 10-15 seconds).

By using the lock/load chamber as both a substrate heating chamber and a cooling chamber, as described above, both the cost of manufacture and the footprint of the apparatus may be reduced. Furthermore, reducing the number of conveyance operations performed by the vacuum conveyance robot increases the throughput of the apparatus. Moreover, because the heating of the substrate is speeded up by having a gas heating space 50 located next to the upper heater 51, and by spraying the substrate located in the H-chamber 47 with gas heated in the gas heating space 50, thereby heating the substrate through convection heating from the upper heater 51, the time required to heat the substrate may be reduced. In addition, because the gas heating space 50 is formed next to the shower plate 52 having many holes 54, and heat is evenly distributed on the entire surface of the substrate inside the H-chamber 47, the substrate surface may be uniformly heated and the occurrence of variations in the temperature of the substrate surface may be reduced. In particular, when the direct heater contact heating method in which the lower heater 56 comes into contact with the substrate is used, the substrate heating time may be further reduced and the throughput of the apparatus may be further increased.

In particular, the throughput may be increased by conveying the unprocessed substrate B to the L/L chamber 13 and subjecting it to preparatory heating while the substrate A is being processed in the substrate processing chamber 20, as described in step 6.

In addition, when the substrate is cooled, the upper heater 51 is turned OFF such that heating does not take place in the gas heating space 50, and the lower heater is also turned OFF. Because N₂ cooling gas supplied to the a chamber 47 via the gas heating space 50 is introduced to the substrate placed inside the C-chamber 48 via the communicating part 39, and the substrate is cooled by the gas through convection heat transfer, the time required to cool the substrate may be reduced.

The time required for processing in the processing chamber 20 is fixed (at 100 seconds to three minutes). and normally cannot be shortened. Therefore, in order to increase throughput, it is useful to subject the substrates that are not being processed to other processes, such as preparatory heating and cooling, while processing is underway in the processing chamber. In addition, where processing is to be continuously performed, efficient use of the interval between processing of one substrate and processing of the next substrate also contributes to increased throughput. In this regard, because in this embodiment the unprocessed substrate B that has completely undergone preparatory heating is received by the arm 27a at the same time that the processed substrate A is received from the processing chamber 20 by the arm 27b in the step 7) comprising the interval between processing of the current substrate and processing of the next substrate, this interval is effectively used, allowing throughput to be further increased.

Furthermore, because the processed substrate A is delivered into the L/L chamber 13 by the arm 27b at the same time that the substrate B that has completely undergone preparatory heating is delivered into the processing chamber 20 by the arm 27a, this interval is effectively used, allowing throughput to be further increased.

In this embodiment, N₂ gas is heated by the upper heater 51 located inside the L/L chamber 13 in order to heat the substrate through radial heating. If only N₂ gas were heated, the upper heater 51 could be located outside the L/L chamber 13. However, if an upper heater 51 located inside the L/L chamber 13 is used in order to heat the substrate through radial heating as described in connection with this embodiment, and the gas is heated as well, the heater may be effectively used and the construction may be simplified.

In this embodiment, the situation was explained in which a conveyance chamber having a vacuum conveyance robot was located separately from the L/L chamber, but it is also acceptable if the conveyance apparatus is located inside the L/L chamber, thereby eliminating one chamber. Moreover, while the front chamber is deemed the L/L chamber in this embodiment, it is also acceptable if it is a heating/cooling chamber having no load/lock function is located separately from the L/L chamber. Because even a heating/cooling chamber having no load/lock function can carry out gas-based convection heating or cooling, the throughput may be increased relative to the situation in which the substrate undergoes only radial heating and natural cooling.

Where the conveyance apparatus is located inside the L/L chamber and the L/L chamber thereby also serves as a conveyance chamber, the C-chamber or the H-chamber may be independent of the L/L chamber.

As described above, in this embodiment, because the L/L chamber is also used as a heating/cooling chamber, the cost of manufacture may be reduced. Moreover, because the heating time and cooling time may be reduced, throughput may be ensured even where heating is carried out on an individual substrate basis. Furthermore, particularly during heating, because the heating gas is directly supplied to the substrate in the form of a shower, the substrate may be uniformly heated. In addition, the present invention may be applied in either a cluster-type or a inline-type substrate processing apparatus.

Incidentally, in the above embodiment, the C-chamber was insulated from any thermal effect of the H-chamber simply through the placement of a partition plate between the H-chamber and the C-chamber. In addition, the cooling that occurs in the C-chamber may be either forced cooling via the H-chamber or natural cooling. As a result, there is a danger that the cooling of the substrate may be inadequate, particularly where the substrate is a glass substrate.

If a glass substrate is extracted from the L/L chamber before it is sufficiently cooled, because it is still hot, there is a possibility that it will melt the resin pad of the arm of the air conveyance robot and the resin part of the cassette 10 that comes into contact with the glass substrate, and that the resin will then adhere to the glass substrate. This in turn raises the risk of an increased defect rate during the apparatus manufacturing process. Therefore, the removal of the high-temperature glass substrate from the L/L chamber takes place only after it has cooled sufficiently in the L/L chamber. Consequently, the cooling performance of the cooling chamber in the L/L chamber has a significant impact on the throughput of the apparatus.

However, where the C-chamber is in close proximity to the H-chamber as shown in FIG. 1, and the two chambers are separated simply by a partition plate made of an insulating material, because the temperature of the C-chamber tends to rise as the temperature of the H-chamber rises, a reduction in the cooling effect occurs. As a result, the time required for cooling of the glass substrate can increase, significantly reducing the apparatus throughput.

It is thus desired to avoid this reduction in the cooling effect and to minimize the cooling time to the extent possible. A variation of the embodiment, described below with reference to FIGS. 5 through 8, addresses this desire by forcibly cooling the partition plate. In FIGS. 5 through 8, the construction of the H-chamber 67 is simplified for ease of explanation.

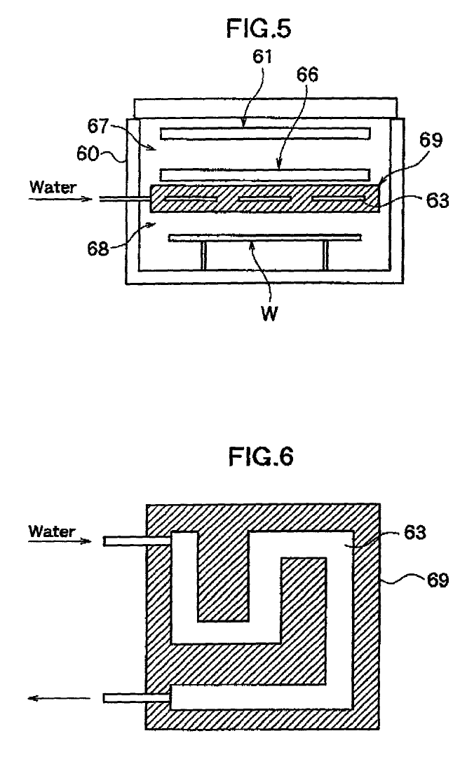

As shown in FIGS. 5 and 6, a liquid channel 63 in which liquid flows is formed in the partition plate 69 that divides the chamber 60 of the L/L chamber into an H-chamber 67 and a C-chamber 68. The liquid chamber 63 is formed in a meandering fashion such that it transfers the cooling energy to the entire surface of the partition plate 69. For the liquid, water is the preferred substance. Cooling may be carried out with the water at room temperature or at a temperature colder than room temperature. Liquid of a fixed temperature is supplied from the exterior of the L/L chamber to the partition plate 69, and liquid is supplied to and evacuated from the liquid channel 63. In this way, the entire partition plate 69 is cooled, and the flow of heat from the H-chamber 67 to the C-chamber 68 is eliminated. As a result, even when the H-chamber 67 is heated to a given temperature, the temperature of the C-chamber does not rise, and there is no reduction in the cooling effect on the substrate B delivered into the C-chamber 68.

Because the partition plate 69 has a water-cooled jacket construction in which water flows inside it, the flow of heat from the C-chamber 68 to the H-chamber 67 is effectively prevented, relative to the case in which the H-chamber 67 and the C-chamber 68 are separated by an ordinary partition plate.

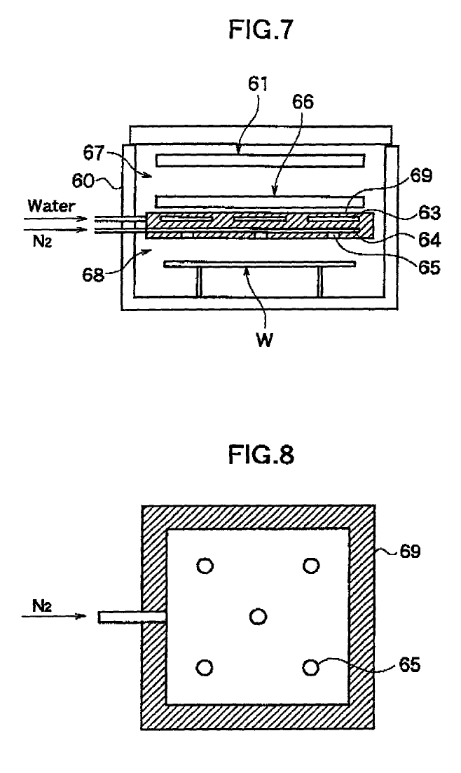

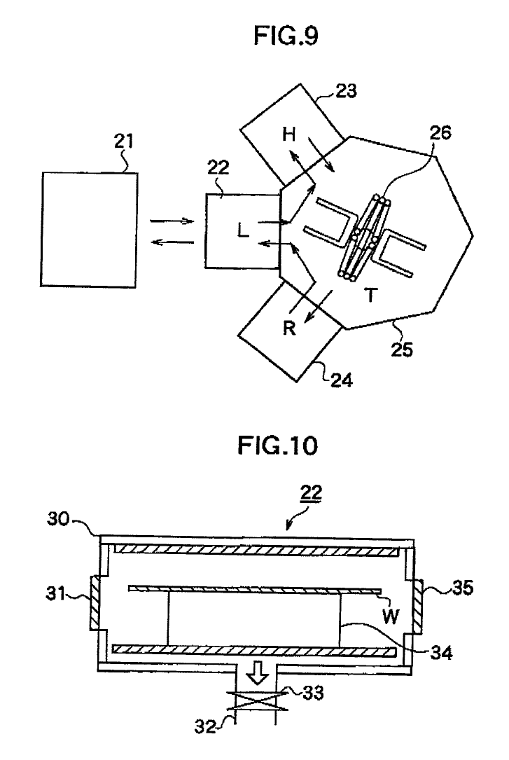

The apparatus shown in FIGS. 7 and 8 is an even more advanced variation that includes, in addition to the liquid channel 69, an air channel 64 in which inert cooling gas flows, as well as a multiplicity of holes 65 formed in the partition plate 69, through which inert gas is supplied in the form of a shower. N₂ gas is supplied from outside the L/L chamber to the partition plate 69 having a water-cooled jacket construction, and is cooled therein. The cooled inert cooling gas is supplied to the substrate in the C-chamber 68 through the multiplicity of holes 65 in the form of a shower. Compared with the case in which the inert cooling gas flows indirectly to the C-chamber 68 via the H-chamber 67, because the gas flows directly onto the substrate, the cooling effect is enhanced and less time is required for cooling to occur. Moreover, cooling via the application of N₂ gas may be carried out while the substrate is exposed to air.

As described above, because water flows in the partition plate and cooling gas is supplied from the partition plate in the form of a shower where necessary, the temperature of the C-chamber does not fluctuate even where the temperature of the H-chamber in the L/L chamber is high. Therefore, because the cooling effect is maintained, a decrease in the apparatus throughput may be prevented. Further improvement in the throughput may be obtained through additional cooling of the substrate using cooled gas, Consequently, the cooling time can be minimized and the throughput increased considerably.

In the variation shown in FIGS. 5 through 8, the H-chamber 67 was explained as having a construction in which inert heating gas was supplied and the substrate was heated, but it is also acceptable if the H-chamber is a radial heat transfer type heating chamber in which the substrate is heated between the upper heater 61 and the lower heater 66, and inert heating gas is not used.

Using the present invention, the throughput of a substrate processing apparatus is increased through the use of an inert gas supply unit that supplies inert heating gas or cooling gas to the front chamber.

What is claimed is:

1. A substrate processing apparatus comprising a substrate processing chamber that processes substrates, a front chamber that houses unprocessed or processed substrates, and a conveyance apparatus that conveys said substrates to said processing chamber or to said front chamber, wherein said front chamber is provided with an inert gas supply unit that supplies to said front chamber inert heating gas for heating said substrates or inert cooling gas for cooling said substrates.

2. The substrate processing apparatus according to claim 1, wherein said inert gas supply unit supplies said inert gas to said substrates in the form of a shower.

3. The substrate processing apparatus according to either claim 1 or claim 2, further comprising a partition that divides said front chamber into a heating chamber and a cooling chamber, a communicating part through which said heating chamber communicates with said cooling chamber, and an exhaust outlet via which gas is exhausted from said front chamber through said communicating part.

4. The substrate processing apparatus according to any of claims 1 through 3, wherein said front chamber is a load/lock chamber.

5. The substrate processing apparatus according to claim 4, wherein one load/lock chamber, one conveyance apparatus and one substrate processing chamber are linearly aligned.

6. The substrate processing apparatus according to claim 5, wherein said conveyance apparatus has two arms capable of conveying said substrates.

7. A method for manufacturing semiconductors comprising the steps of;
in the load/lock chamber that houses unprocessed or processed substrates, subjecting said unprocessed substrates to preparatory heating using inert heating gas, or cooling said processed substrates using inert cooling gas; and
conveying said pre-heated substrates from said load/lock chamber to the substrate processing chamber, or conveying said processed substrates from said substrate processing chamber to said load/lock chamber, by means of a conveying apparatus for conveying substrates;
wherein the substrates conveyed between said load/lock chamber and said substrate processing chamber are linearly conveyed.

8. The semiconductor manufacturing method according to claim 7, wherein unprocessed substrates are conveyed to said load/lock chamber and preparatory heating thereof is completed while substrates are being processed in said substrate processing chamber.

9. The semiconductor manufacturing method according to claim 8, wherein said conveyance apparatus has two conveying arms capable of conveying, and, at the same time that the unprocessed substrate that has completely undergone preparatory heating is received by one arm, a processed substrate is received from said substrate processing chamber by the other arm, next, at the same time that the substrate that has completely undergone preparatory heating is delivered into the substrate processing chamber by said one arm, the processed substrate is delivered into the cooling chamber by said the other arm.
